(19) United States
(12) Patent Application Publication
(10) Pub. No.: US 2005/0213937 A1
(43) Pub. Date: Sep. 29, 2005

(54) Recording and reproducing apparatus with simple timer recording reservation function

(75) Inventor: Hiroyuki Miyazaki, Takefu-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 11/076,330

(22) Filed: Mar. 10, 2005

(30) Foreign Application Priority Data
Mar. 24, 2004 (JP) 2004-087714

(51) Int. Cl. H04N 5/76; G06F 3/00; H04N 5/445; G06F 13/00; H04N 5/91

(52) U.S. Cl. 386/83; 725/58

(57) ABSTRACT

A recording and reproducing apparatus capable of making a timer recording reservation for a television program broadcast in a certain time zone at a time corresponding to a broadcast time of a next program in the series while using existing recording data on a past program in the series, and requiring a viewer to only perform a simple operation is provided. The recording and reproducing apparatus automatically corrects a recording start time and a recording end time necessary to record the next program in the series by a predetermined time, e.g., fractions less than 15 minutes based on recording data on the past recorded program so as not to cut a beginning part or a final part of the program.

### BACKGROUND OF THE INVENTION

1. Field of the Invention

The present invention relates to a recording and reproducing apparatus that includes a function capable of simply making a television (TV) timer recording reservation based on title information already recorded in a recording medium such as a digital versatile disk (DVD).

2. Description of the Related Art

Conventionally, a technique for making a TV timer recording reservation by a recording and reproducing apparatus has widely spread. As for a recording reservation for TV programs, e.g., a serial drama, broadcast every week, everyday, or in a certain time zone, many techniques intended to minimize time and labor for an input operation necessary for a viewer to make the recording reservation by using existing recording data on a past broadcast program in the series are disclosed.

The conventional techniques using the recording data on the present program in the series for a recording reservation for subsequent programs in the series have, however, the following disadvantages. If a viewer starts recording a TV program in series, which the viewer views for the first time, in the middle of the program, and decides to make a recording reservation for a next program in the series, then a next recording start time is set at the same time as a present recording start time. As a result, a beginning part of the program to be recorded next is cut off. To avoid this disadvantage, the viewer is required to open a timer recording screen after the program finishes and to perform an ordinary setting operation necessary for the timer recording on the screen. It takes., therefore, time and labor.

A recording and reproducing apparatus disclosed in Patent Literature 1 is premised on a video apparatus. This apparatus solves the above-stated disadvantages that occur when the viewer starts recording a TV program in series, which the viewer views for the first time, in the middle of the program and decides to make the recording reservation for the next program in the series, as follows. When the viewer performs a recording stop operation simultaneously with an end of the program in the series, the recording and reproducing apparatus displays a message to the effect that “Do you plan to make a timer recording of subsequent programs in the series to the program recorded this time every week, everyday, or in the same time zone?” on a screen for the viewer so as to confirm a viewer's intention. In addition, a step of correcting the recording start time of the timer recording reservation to an original start time of the programs in the series is inserted.

Apart from the above-stated instance, a planned broadcast time of the next program in the series which the viewer is to record often differs from the time zone of the previously recorded program for some reason. The conventional timer recording reservation method cannot cope with this situation, so that the viewer is required to manually open the timer recording screen and to perform the ordinary setting operation necessary for the timer recording on the screen. It, therefore, disadvantageously takes time and labor.

A recording and reproducing apparatus disclosed in Patent Literature 2 is premised on a video apparatus. This apparatus solves the above-stated disadvantages as follows. Even if the broadcast time of the program which the viewer wants to record differs from the broadcast time of the previously recorded program in the same series, the apparatus retrieves latest broadcast schedule information included in a digital broadcasting signal, thereby making it unnecessary for the viewer to manually perform the ordinary setting operation necessary for the timer recording and making it possible for the viewer to make a proper timer recording reservation by a simple operation.

Thanks to these measures, the viewer can make a timer recording reservation for TV programs, e.g., a serial drama, broadcast every week, everyday, or in the certain time zone, at the recording start time accurately corresponding to the next program start time by the simple operation while using the existing recording data on the past program in the series.

[Patent Literature 1] Japanese Patent Application Laid-Open No. 2002-223410

[Patent Literature 2] Japanese Patent Application Laid-Open No. 2001-257974

The recording and reproducing apparatus disclosed in the Patent Literature 1 has, however, the following disadvantages. If the viewer records the program which the viewer currently views, the viewer is required to respond to the recording and reproducing apparatus using a remote controller or the like as to whether the viewer is to make a timer recording reservation for the next program in the series whenever the recording of the present program is finished. The viewer is forced to perform the operation using the remote controller or the like particularly if the viewer is not to make the timer recording reservation for the next program in the series. Further, if the viewer is to make a recording reservation for a TV program broadcast while the viewer is absent, the desired program can be recorded even when the viewer is absent by making a timer recording reservation setting in advance. If so, however, the viewer cannot respond to the recording and reproducing apparatus disclosed in the Patent Literature 1 as to whether the viewer wants to make a timer recording reservation for the next program in the series when the recording is finished.

The Patent Literature 2 provides the recording and reproducing apparatus that enables making a proper timer recording reservation setting by a simple operation by storing latest broadcast schedule information included in the broadcasting signal of the currently recorded program in the recording and reproducing apparatus even if the broadcast time of the next program in the series differs from that of the currently recorded program. However, the broadcast schedule information indispensable to these measures is included only in the digital broadcasting signal. The measures are not, therefore, applied to still leading analog broadcasting.

### SUMMARY OF THE INVENTION

The present invention has been achieved to solve the conventional disadvantages.

According to a first aspect of the present invention, there is provided a recording and reproducing apparatus according to a first comprising: means for reading title information related to a recording operation from a recording medium in which target data is recorded; means for selecting recording reservation information necessary for a new recording reservation from the read title information; and means for displaying on a display screen, recording reservation information data consisting of the recording reservation information including at least a recording date, a recording start time, and a recording end time in the read title information as a recording reservation menu. According to a second aspect of the present invention, there is provided the recording and reproducing apparatus according to the first aspect, comprising: the means for reading the title information related to the recording operation from the recording medium in which the target data is recorded; the means for selecting the recording reservation information necessary for the new recording reservation from the read title information; means for replacing a first recording date in the read title information by a second recording date; the means for displaying on the display screen, the recording reservation information data consisting of the recording reservation information including the second recording date as the recording reservation menu; and means for changing the recording reservation information data displayed as the recording reservation menu on the display screen to user's desired data.

According to a third aspect of the present invention, there is provided the recording and reproducing apparatus according to the first aspect of the invention, comprising: the means for reading the title information related to the recording operation from the recording medium in which the target data is recorded; the means for selecting the recording reservation information necessary for the new recording reservation from the read title information; means for correcting a first recording start time and a first recording end time in the read title information to a second recording start time and a second recording end time, respectively; the means for displaying on the display screen, the recording reservation information data consisting of the recording reservation information including the second recording start time and the second recording end time as the recording reservation menu; and the means for changing the recording reservation information data displayed as the recording reservation menu on the display screen to user's desired data.

The present invention can provide the recording and reproducing apparatus that can make a timer recording reservation for TV programs, e.g., a serial drama, broadcast every week, everyday, or in the certain time zone, at the recording start time accurately corresponding to the next program start time or the program end time while using existing recording data on the past program in the series and requiring the viewer to perform only a simple operation, irrespective of analog broadcasting and digital broadcasting.

### BRIEF DESCRIPTION OF THE DRAWINGS

FIG. 1 is a flowchart that shows operations performed by a recording and reproducing apparatus according to embodiments of the present invention;

FIG. 2 is a flowchart that shows an operation for correcting a recording start time and a recording end time;

FIG. 3 is a block diagram of an AV apparatus set according to the embodiments of the present invention;

FIG. 4 is a block diagram of a control microcomputer;

FIG. 5 is a typical view of title information stored in a firsts field register according to a first embodiment of the present invention;

FIG. 6 depicts an example of a title menu screen;

FIG. 7 depicts another example of the title menu screen;

FIG. 8 depicts an operation indication screen;

FIG. 9 depicts a setup menu screen;

FIG. 10 depicts a recording reservation correction temporary register;

FIG. 11 depicts a recording reservation correction temporary register;

FIG. 12 depicts the recording reservation register; and

FIG. 13 depicts a setup menu screen.

### DESCRIPTION OF THE PREFERRED EMBODIMENT

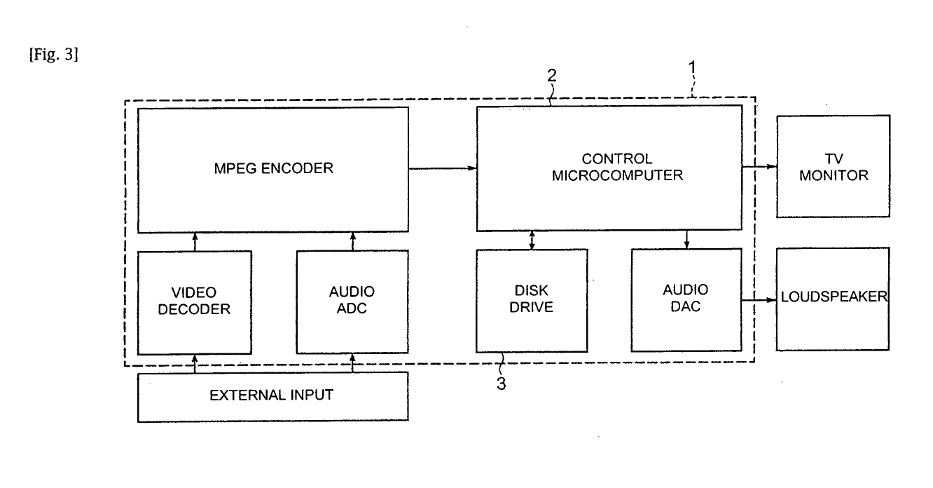

Exemplary embodiments of the present invention will be described, while referring to an instance of making a timer recording reservation for a TV program which a viewer currently views using an electronic recording and reproducing apparatus such as a DVD-R/RW. FIG. 3 is a block diagram that shows a configuration of an AV apparatus set including an electronic recording and reproducing apparatus 1. A disk drive 3 represents a DVD loader or a hard disk drive (HDD) . Referring to FIG. 3, when video and voice signals transmitted from a broadcasting station selected by a tuner is externally input, the input video and voice signals are subjected to a processing by an MPEG encoder. Based on an operation command to the electronic recording and reproducing apparatus 1 transmitted from a control microcomputer 2, various operations such as output of an image to a TV monitor, output of a voice to a loudspeaker, or recording of video and voice signal data to a DVD or the HDD are performed according to a viewer's desire.

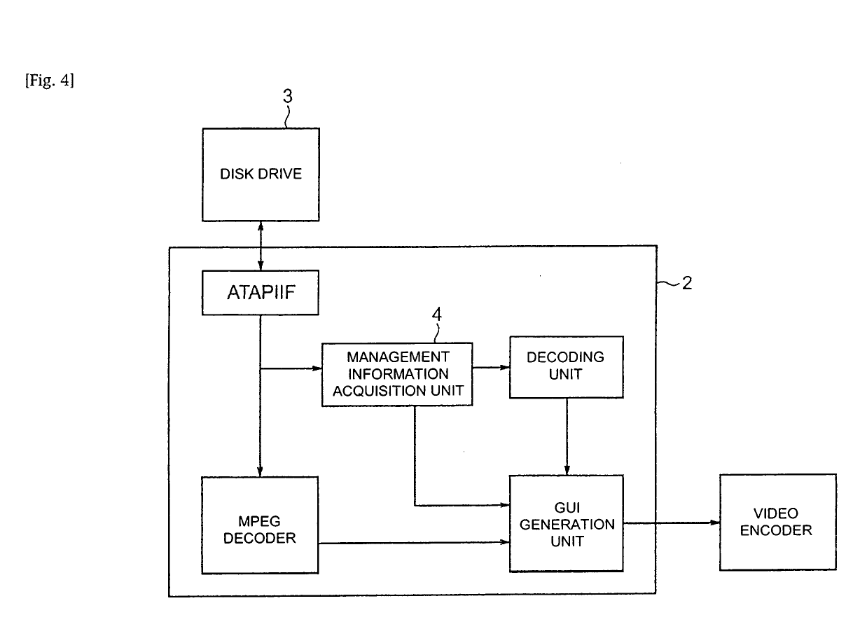

FIG. 4 is a block diagram which shows an interior of the control microcomputer 2. An ATAPIIF is an interface unit that reads and writes the video and voice signal data stored in the DVD or the HDD from and to the disk drive 3, and reads and writes management information on each title of a program to be recorded in the DVD. This title-specific management information includes at least data such as title, a recording date (year/month/day), a recording start time, a recording time, a recording channel, a recording mode, and a recording end time. These pieces of data will be generically referred to as “title information” hereinafter. A management information acquisition unit 4 acquires the title information read by the ATAPIIF, stores necessary data, performs an arithmetic operation, stores data on an arithmetic operation result, and supplies necessary data to a GUI generation unit that generates a menu screen, according to a predetermined microcomputer program.

The present invention is intended to simplify a menu screen operation as much as possible when the viewer makes a new timer recording reservation using already recorded past title information. For this reason, an emphasis is put on how to execute a setting of a timer recording reservation such as week-based setting by default on a setup menu screen from the already recorded past title information.

In the following embodiments, a temporary register for recording reservation correction and a register for recording reservation appear. The temporary register for recording reservation correction temporarily stores the past recorded title information, and replaces stored past date data (year/month/day) by present Y-M-D date data (year/month/day) on a present date at which the viewer is to make a timer recording reservation. Further, the after-replacement date data (year/month/day/hour/minute) stored in the temporary register for recording reservation correction is compared with the present Y-M-D-H-M date data (year/month/day/hour/minute) according to the microcomputer program. If the after-replacement date data (year/month/day/hour/minute) stored in the temporary register for recording reservation correction is “past” date data relative to the present Y-M-D-H-M date data (year/month/day/hour/minute), the recording type is set at “Every Week” by default. Conversely, if the after-replacement date data (year/month/day/hour/minute) stored in the temporary register for recording reservation correction is “future” date data relative to the present Y-M-D-H-M date data (year/month/day/hour/minute), the recording type is set at “Once” by default, since still there is a possibility left that the program to be recorded by the timer recording reservation is broadcast later on the same day. Further, the register for recording reservation stores recording reservation data for allowing the viewer to make a registration on the setup menu screen.

FIRST EMBODIMENT

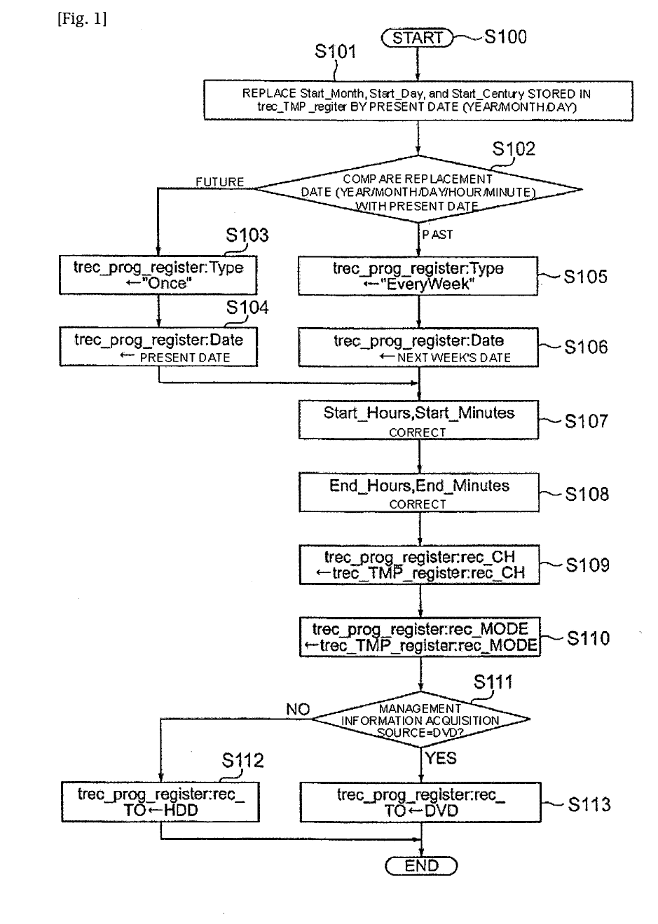

As a first embodiment, an instance of making the timer recording reservation for the TV program which the viewer currently views using the electronic recording and reproducing apparatus such as the DVD-R/RW and using the DVD as an electronic recording medium will be described with reference to the flowchart shown in FIG. 1. If TV programs are to be recorded in the DVD, then a first field register and a last field register for each recorded title are provided in the DVD, and the title information such as the title, the recording date (year/month/day), the recording start time, the recording channel, the recording mode is stored in each of the first field register and the last field register. The recording time is stored in a location other than the first field register and the last field register of the same DVD.

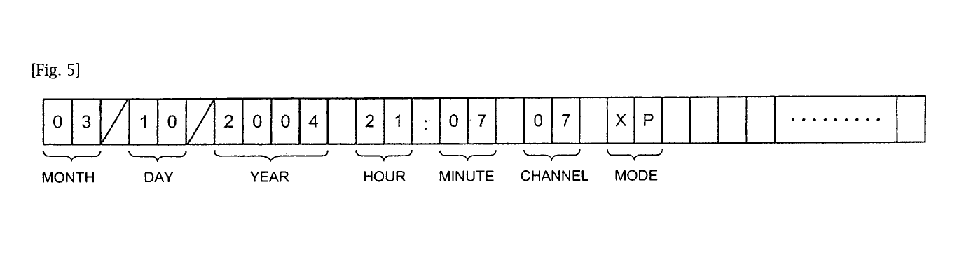

While viewing a first program of programs in series scheduled to be broadcast every week on channel 7 at 21:00 to 22:00, on Mar. 10 (Wednesday), 2004, the viewer decides at 21:07 to record TV programs in the series including the present program every week, and causes the electronic recording and reproducing apparatus to start a recording operation in an XP mode at 21:07. The program in the series ends at 22:00, and the viewer causes the electronic recording and reproducing apparatus to finish the recording operation at 22:01. An actual recording time is 54 minutes. At this moment, for the title recorded in the DVD, the title information such as the recording date (year/month/day), the recording start time, the recording channel, and the recording mode is stored in each of the first field register and the last field register of the DVD. In this instance, storage of the title information in each of the first field register and the last field register is as shown in FIG. 5.

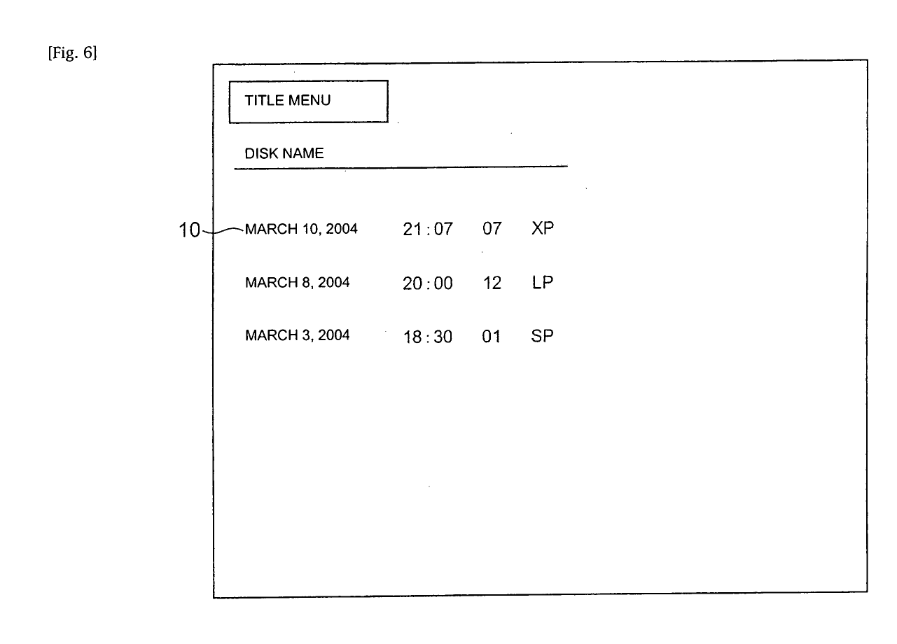

At 21:30 on the next day of March 11 (Thursday), the viewer decides to make a timer recording reservation for the next TV program scheduled to be broadcast next week in the series, following to the program recorded from 21:07 to 22:01 on yesterday of March 10 (Wednesday). The viewer installs the DVD employed to record the program yesterday into the disk drive 3, and opens a title menu screen using a remote controller or the like. FIG. 6 depicts an example of this title menu screen. Since two other programs are previously recorded in the DVD, titles of three recorded programs including the program 10 recorded yesterday are displayed on the title menu screen shown in FIG. 6.

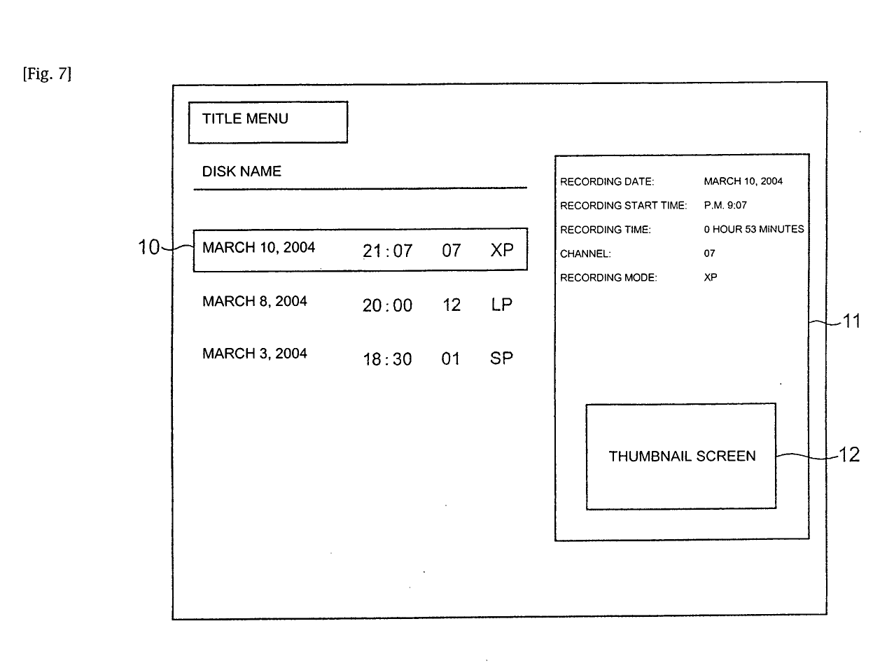

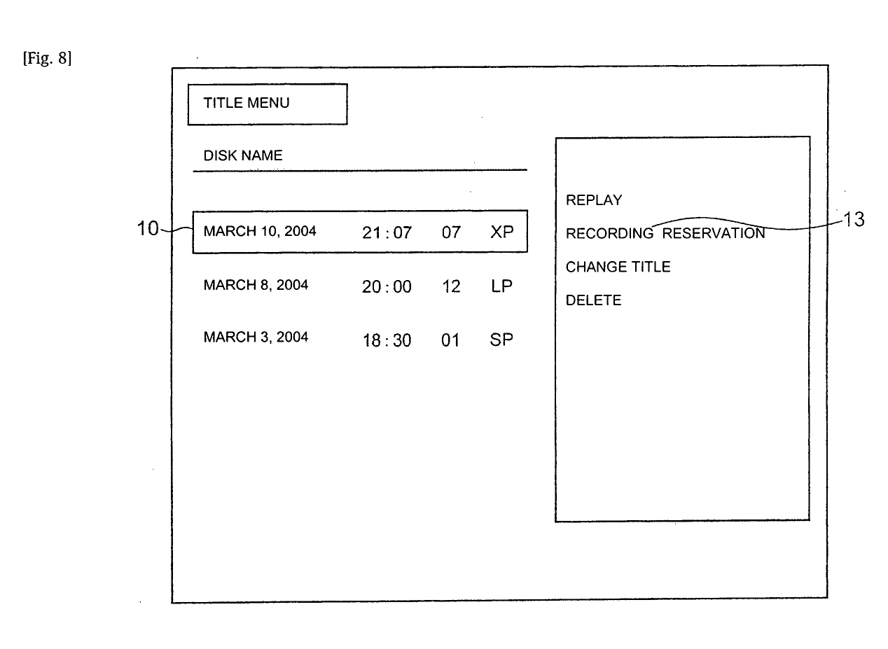

At a step S100 shown in FIG. 1, the viewer selects the title of the program for which the timer recording reservation is to be made from among the three titles recorded in the DVD using the remote controller or the like. If the viewer selects the program 10 recorded yesterday, title information 11 on the selected program 10 is displayed in the right of the screen as shown in FIG. 7. As shown in FIG. 7, a thumbnail screen 12 can be also displayed according to the title information. Therefore, the title menu screen is user-friendly when the viewer is to know of a content of the past recorded program. The viewer, who decides to make the recording reservation for the next program in the series to the present program, clicks on the title 10 of the program shown in FIG. 7 by operating the remote controller. The title menu screen shown in FIG. 8 is displayed, accordingly.

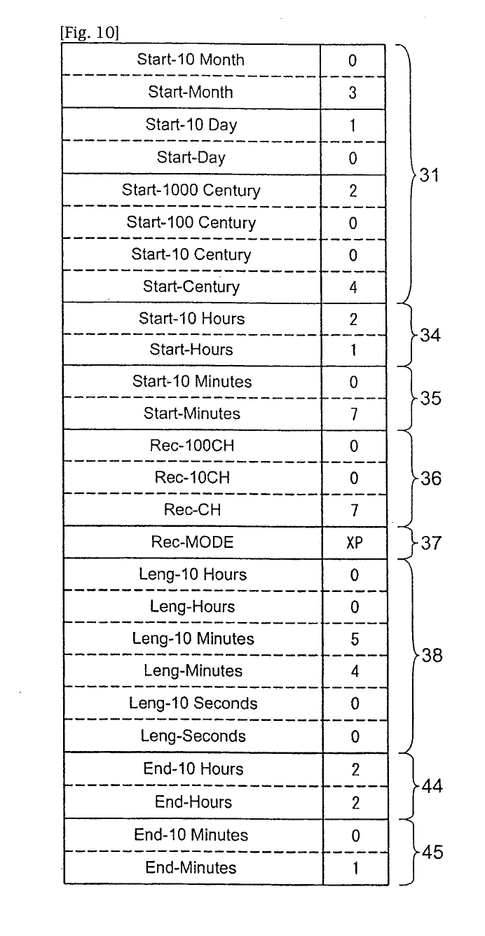

At this moment, if the viewer selects a recording reservation 13, then the management information acquisition unit 4 of the control microcomputer 2 acquires the recording reservation information such as the title, the recording date (year/month/day), the recording start time, the recording time, the recording channel, the recording mode, and the recording end time from the title information on the title recorded in the first field register or the like of the DVD as shown in FIG. 5, and stores the acquired recording reservation information in the temporary register for recording reservation correction included in the management information acquisition unit 4. The temporary register for recording reservation correction has a structure shown in FIG. 10, and stores data such as the recording year, month, and day 31, the recording start time (indicated by reference symbols 34 and 35), the recording channel 36, the recording mode 37, the recording time 38, and the recording end time (indicated by reference symbols 44 and 45).

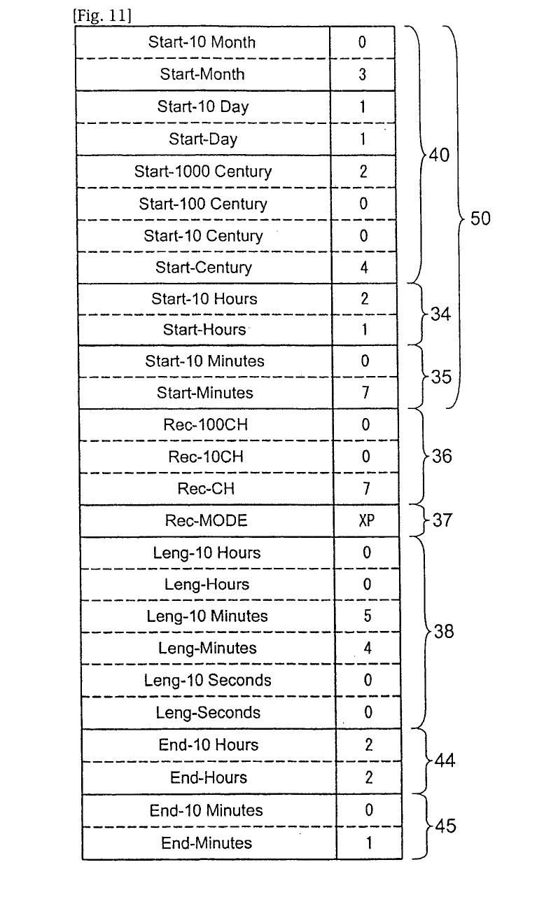

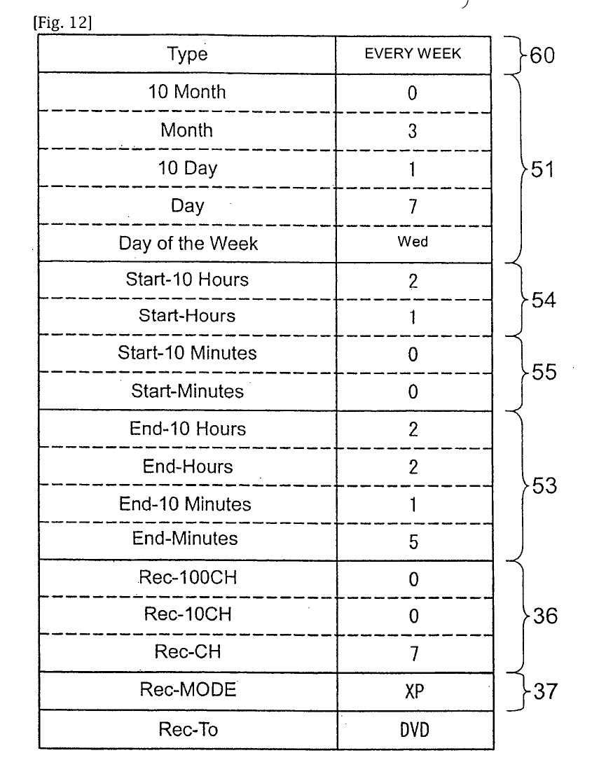

At a step S101 shown in FIG. 1, the management information acquisition unit 4 replaces the data on recording year, month, and day 31 among the recording preservation information stored in the temporary register for recording reservation correction by a present Y-M-D date data (year/month/day). It is Mar. 11 (Thursday), 2004 today. Therefore, if the data on year, month, and day 31 stored in the temporary register for recording reservation correction before replacement shown in FIG. 10 is compared with the present date, only data on year, month, and day 40 is replaced by the present date in the temporary register for recording reservation correction after the replacement shown in FIG. 11. At a step S102, the management information acquisition unit 4 compares date data (year/month/day/hour/minute) in the temporary register for recording reservation correction after the replacement shown in FIG. 11 with the preset date data (year/month/day/hour/minute). The date data (year/month/day/hour/minute) 50 in the temporary register for recording reservation correction after the replacement shown in FIG. 11 is 21:07 on Mar. 11, 2004, whereas the present date data (year/month/day/hour/minute) is 21:30 on Mar. 11, 2004. The management information acquisition unit 4, therefore, determines that the date data 50 in the temporary register for recording reservation correction after the replacement is “past” date data relative to the present date data (“PAST” at the step S102). Accordingly, at a step S105, the management information acquisition unit 4 sets the recording type at “Every Week” by default, and stores “Every Week” 60 in the recording reservation register as shown in FIG. 12. At a step S106, the management information acquisition unit 4 stores “March 17 (Wednesday)” 51 at which the next program in the series is broadcast, in the recording reservation register as the recording date (month/day).

The actual recording start time when the program is recorded yesterday of March 10 (Wednesday) will be referred to as “first recording start time”, and the actual recording end time will be referred to as “first recording end time”, hereinafter. In addition, the recording start time used for the timer recording reservation will be referred to as “second recording start time”, and the recording end time used for the timer recording reservation will be referred to as “second recording end time”, hereinafter. The first recording start time is 21:07 (indicated by reference symbols 34 and 35 shown in FIG. 11), and the first recording end time is 22:01 (denoted by reference symbols 44 and 45 shown in FIG. 11). If a next timer recording is executed using these pieces of data, a beginning part of the next program is cut off. To solve this disadvantage, a time correction is carried out to the recording start time and the recording end time for the timer recording reservation through the following steps. The viewer can set a correction set value used to correct the relevant time in advance. In this embodiment, the correction set value is 15 minutes so that each of the second recording start time and the second recording end time is set at one of 0 minute, 15 minutes, 30 minutes, and 45 minutes. However, no problem occurs even if such a correction set value is not set.

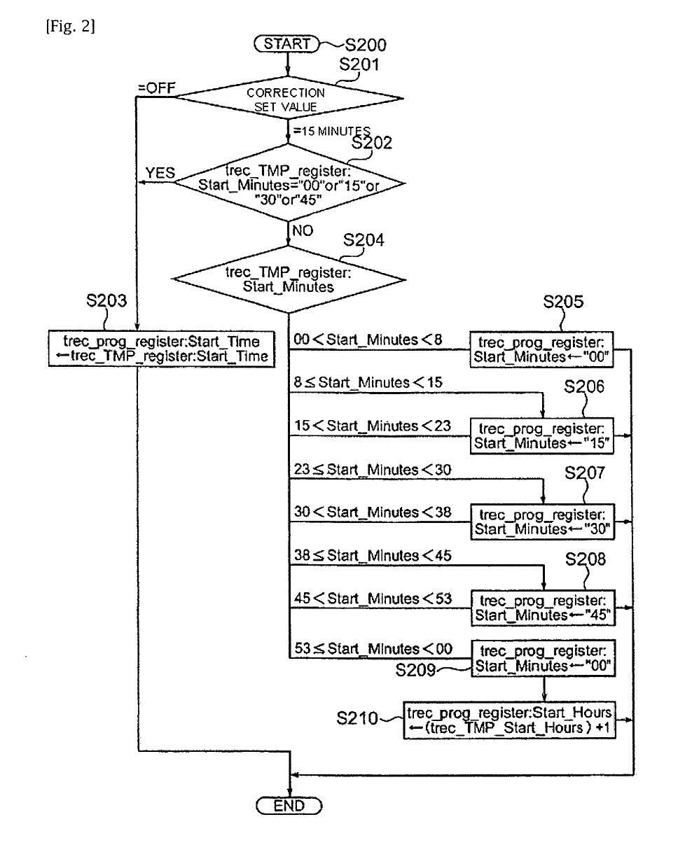

At a step S107 shown in FIG. 1, the management information acquisition unit 4 executes a correction of the recording start time used for the timer recording reservation. Detailed steps in the step S107 will be described with reference to FIG. 2. At a step S201, the management information acquisition unit 4 checks the correction set value. In this embodiment, the correction set value is 15 minutes (“15 minutes” at the step S201) . At a step S202, the management information acquisition unit 4 retrieves a recording start minutes' time (indicated by reference symbol 35 shown in FIG. 11) stored in the temporary register for recording reservation correction, and determines that the recording start minutes' time is 7 minutes. Since the 7 minutes' time is not an integer multiple of 15 minutes (“No” at a step S204), the correction is carried out to the recording start minutes' time according to the program shown in this flowchart of FIG. 2. In this embodiment, the 7 minutes' time satisfies a condition of 00<Start_Minutes<8. Accordingly, at a step S205, the recording start minutes' time is corrected to 0 minute, and the 0 minute's time after the correction is stored in the recording reservation register as the recording start minutes' time (indicated by reference symbol 55 shown in FIG. 12). Through these steps, the first starting time of 21:07 (indicated by the reference symbols 34 and 35 shown in FIG. 11) can be corrected to the second recording start time of 21:00 (indicated by reference symbols 54 and 55 show in FIG. 12).

The step of correcting the first recording end time to the second recording end time is a step S108 shown in FIG. 1. Since the step S108 is substantially equal in structure to the step S107 described above, it will not be repeatedly described herein. It is added, however, that for the correction of the recording end time, a correction vector of the recording end time is opposite to a correction vector of the recording start time. This is because the second recording end time needs to be set to be after the first recording end time so as to prevent a final part of the program to be recorded from being cut off.

At steps S109 and S110 shown in FIG. 1, the management information acquisition unit 4 stores a recording channel (indicated by reference symbol 36 shown in FIG. 11) and a recording mode (indicated by reference symbol 37 shown in FIG. 11) stored in the temporary register for recording reservation correction, in the recording reservation register as a recording channel (indicated by reference symbol 36 shown in FIG. 12) and a recording mode (indicated by reference symbol 37 shown in FIG. 12), respectively. The recording reservation register shown in FIG. 12 is finally provided.

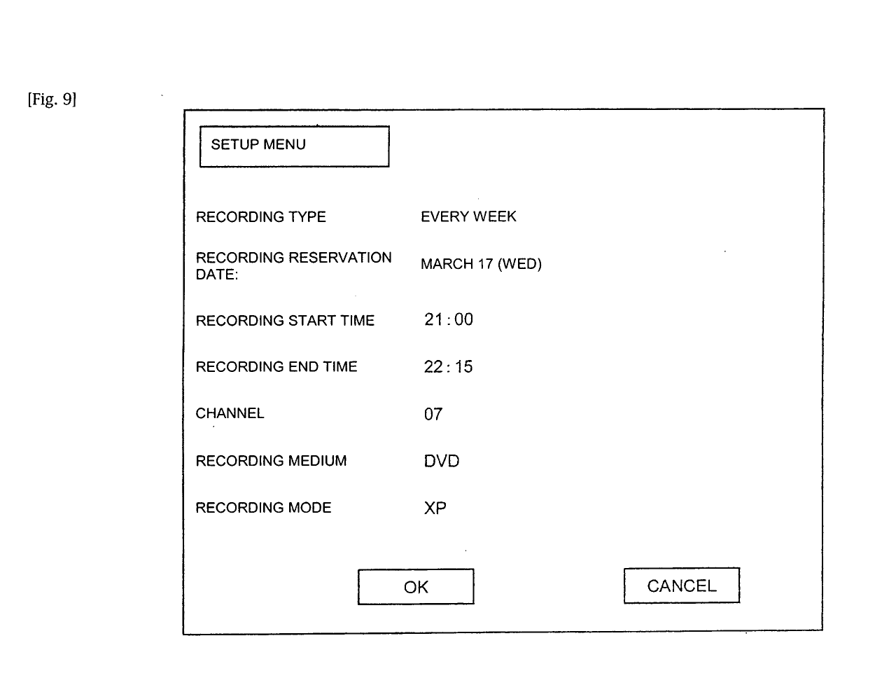

At this moment, the setup menu screen shown in FIG. 9 is displayed on the TV monitor or the like. If the viewer selects OK on this setup menu screen, the recording reservation register (shown in FIG. 12) is stored, thereby finishing the viewer desired timer recording reservation. Needless to say, items displayed on the setup menu screen can be appropriately changed by operating the remote controller or the like if the viewer wants to change displayed contents.

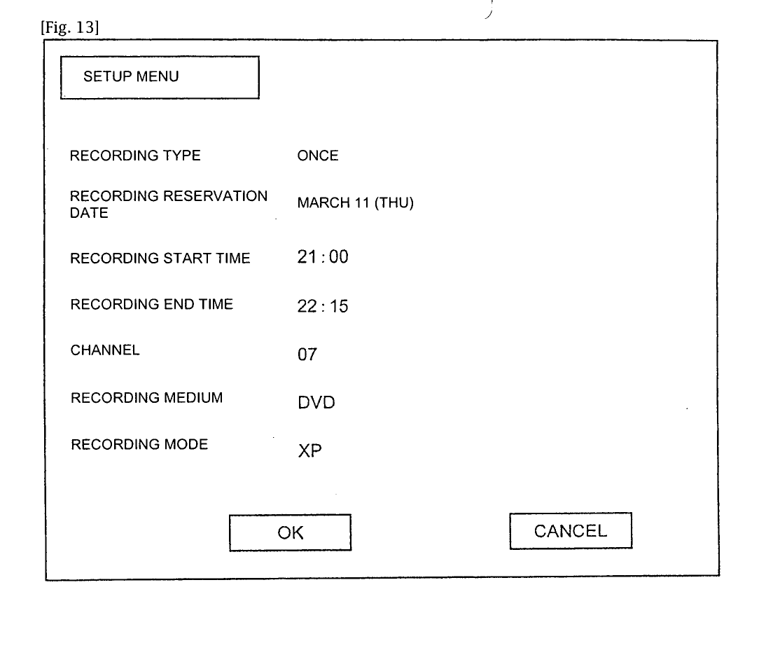

In this embodiment, the instance has been described on premise that the viewer decides to make the timer recording reservation for the next program in the series to the TV program recorded from 21:07 to 22:01 on March 10 (Wednesday), at 21:30 on the next day of March 11 (Thursday). It is now premised that the viewer decides to make the timer recording reservation for the next program in the series at 10: 00 on the next day of March 11 (Thursday). On this premise, at the step S102 shown in FIG. 1, the management information acquisition unit 4 compares the date data (year/month/day/hour/minute) in the temporary register for recording reservation correction after the replacement shown in FIG. 11 with the present date data (year/month/day/hour/minute). The date data (year/month/day/hour/minute) 50 in the temporary register for recording reservation correction after the replacement is 21:07 on Mar. 11, 2004, whereas the present date data (year/month/day/hour/minute) is 10:00 on Mar. 11, 2004. The management information acquisition unit 4, therefore, determines that the date data (year/month/day/hour/minute) 50 in the temporary register for recording reservation correction after the replacement is “future” date data relative to the present date data (“FUTURE” at the step S102). Accordingly, at a step S103, the management information acquisition unit 4 sets the recording type at “Once” by default. Finally, the setup menu screen shown in FIG. 13 is displayed. Needless to say, items displayed on the setup menu screen can be appropriately changed by operating the remote controller or the like if the viewer wants to change displayed contents.

SECOND EMBODIMENT

In the first embodiment, the instance of using a first DVD that has a history of recording at least one title in the past as the recording medium has been described. In a second embodiment, an instance of using a second DVD that has been just bought and that does not record any title at all as a recording medium will be described. First, the first DVD is installed to the disk drive 3 of the electronic recording and reproducing apparatus 1, and the viewer selects the TV program 10 for which a timer recording reservation is to be made (see FIG. 7) on the title menu screen (shown in FIG. 6). If the viewer then selects the recording reservation 13 on the operation indication screen (shown in FIG. 8), then the title information stored in the first DVD is extracted and the extracted title information is temporarily stored in the management information acquisition unit 4 included in the microcomputer 2 according to the microcomputer program similarly to the first embodiment. The temporary register for recording reservation correction (shown in FIG. 11) is then generated according to the microcomputer program based on the stored title information as described in the first embodiment. At this moment, the first DVD installed to the disk drive 3 is detached from the disk drive 3, the second DVD is installed to the disk drive 3, and the recording reservation can be completed according to the setup menu screen (shown in FIG. 9) displayed on the screen.

THIRD EMBODIMENT

In the first and the second embodiments, the instances of using the DVD as the electronic recording medium have been described. In a third embodiment, an instance of using not the DVD but the HDD as the electronic recording medium will be described. The HDD holds a first field register and a last field register for each title similarly to the DVD. A simple timer recording reservation can be, therefore, made through exactly the same procedures as those for the steps described in the first embodiment. The only difference is that a title information storage location of the DVD is the DVD itself whereas a title information storage location of the HDD is the electronic recording and reproducing apparatus 1.

In the embodiments stated so far, when the timer recording reservation is executed, the recording type is set at “Every Week” or “Once” by default. The default recording type can be appropriately changed to, for example, “Next Day” or “Everyday” according to a viewer's need.

As for the correction of the recording start time or the recording end time at the steps S205 to S210 shown in FIG. 2, the default correction set value is 15 minutes in the above-stated embodiments. This default correction set value can be arbitrarily changed by the viewer. Further, the default setting of the correction set value can be made for each of the recording start time and the recording end time. If so, by viewer's changing the default setting of the recording end time, the recording end time of 22:15 displayed on the setup menu screen shown in FIG. 9 can be changed to 22:00.

1. A recording and reproducing apparatus comprising:
means for reading title information related to a recording operation from a recording medium in which target data is recorded;
means for selecting recording reservation information necessary for a new recording reservation from the read title information; and
means for displaying, on a display screen, recording reservation information data consisting of the recording reservation information including at least a recording date, a recording start time, and a recording end time in the read title information as a recording reservation menu.

2. The recording and reproducing apparatus according to claim 1, comprising:
the means for reading the title information related to the recording operation from the recording medium in which the target data is recorded;
the means for selecting the recording reservation information necessary for the new recording reservation from the read title information;
means for replacing a first recording date in the read title information by a second recording date;
the means for displaying, on the display screen, the recording reservation information data consisting of the recording reservation information including the second recording date as the recording reservation menu; and
means for changing the recording reservation information data displayed as the recording reservation menu on the display screen to user is desired data.

3. The recording and reproducing apparatus according to claim 1, comprising:
the means for reading the title information related to the recording operation from the recording medium in which the target data is recorded;
the means for selecting the recording reservation information necessary for the new recording reservation from the read title information;
means for correcting a first recording start time and a first recording end time in the read title information to a second recording start time and a second recording end time, respectively;
the means for displaying, on the display screen, the recording reservation information data consisting of the recording reservation information including the second recording start time and the second recording end time as the recording reservation menu; and
the means for changing the recording reservation information data displayed as the recording reservation menu on the display screen to user's desired data.
